(19) United States
(12) Patent Application Publication
(10) Pub. No.: US 2008/0062194 A1
(43) Pub. Date: Mar. 13, 2008

(54) METHOD OF DETECTING GLOBAL IMAGE, DISPLAY APPARATUS EMPLOYING THE METHOD AND METHOD OF DRIVING THE DISPLAY APPARATUS

(76) Inventors: Jae-Hyeung PARK, Seoul (KR); Tae-Sung Kim, Suwon-si (KR); Hyoung-Sik Nam, Yeonsu-gu (KR)

Correspondence Address: MACPHERSON KWOK CHEN & HEID LLP, 2033 GATEWAY PLACE, SUITE 400, SAN JOSE, CA, 95110, US

(21) Appl. No.: 11/851,296

(22) Filed: Sep. 6, 2007

(30) Foreign Application Priority Data
Sep. 7, 2006 (KR) 10-2006-0085948

(51) Int. Cl. G09G 5/00

(52) U.S. Cl. 345/618; 345/55

(57) ABSTRACT

A method and apparatus for detecting a global image and removing image blur includes receiving an n-th frame in a frame period, presuming a motion of the n-th frame by using the n-th frame and a previous frame of the n-th frame, determining the kind of motion picture of the n-th frame based on the presumed motion, generating an n-th compensating frame according to the kind of motion picture and displaying the n-th frame and the n-th compensating frame, in sequence.

### CROSS-REFERENCE TO RELATED APPLICATIONS

This application claims priority under 35 U.S.C. §119 to Korean Patent Application No. 2006-0085948, filed on Sep. 7, 2006, in the Korean Intellectual Property Office (KIPO), the contents of which are herein incorporated by reference in their entirety.

### BACKGROUND OF THE INVENTION

1. Field of the Invention

The present invention relates to a method of detecting a global image, a display apparatus employing the method, a method of driving the display apparatus and, more particularly, to a method and apparatus for improving the quality of a motion picture display.

2. Description of the Related Art

When a high-speed motion picture is displayed on an LCD apparatus that employs the sample and hold method, the picture may be blurred by the persistence a previous image displayed for several frames as an afterimage.

When various motions are displayed in one screen, motion blur may not be recognized because the eye cannot follow motions that last a short period. However, when a uniform motion lasts for a long period in an area, motion blur is easily recognized on the screen. For example, in a global image or a scroll image, motion blur may occur because an entire (or most) of the screen is moving constantly. The scroll image moves vertically or horizontally toward ends of the screen in real time. In particular, an input image of the scroll image has no motion blur, so that the displayed image of the scroll image has greatly increased motion blur.

### SUMMARY OF THE INVENTION

According to one aspect of the present invention, a display apparatus capable of improved display of a motion picture employs a driving method wherein the kind of motion picture in an n-th frame is detected by using the n-th frame and a previous frame, determining the kind of a motion picture of the n-th frame based on the presumed motion, generating an n-th compensating frame according to the kind of the motion picture, and displaying the n-th frame and the n-th compensating frame, in sequence, where n is a natural number.

In another example embodiment of the present invention, the method of detecting a global image includes calculating a plurality of motion vectors from the changed positions of k-number of blocks in an n-th frame and each sequential previous frames, presuming a motion vector of the n-th frame by analyzing a plurality of motion vectors and determining the n-th frame as the global image when the motion vector of the n-th frame has constant direction and size, where n and k are natural numbers.

In still another example embodiment of the present invention, a display apparatus includes a motion presumption part, a compensating control part, a compensating part and a display panel. The motion presumption part presumes a motion of an n-th frame by using the n-th frame received in a frame period and a stored previous frame prior to the n-th frame where, n is a natural number. The compensating control part determines the kind of a motion picture of the n-th frame based on the presumed motion. The compensating part generates an n-th compensating frame according to the kind of the motion picture. The display panel displays the n-th frame and the n-th compensating frame in the frame period.

According to the method of detecting a global image, image blur is removed and a manufacturing cost is reduced effectively by compensating the image data selectively according to the signal of the input motion picture.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram illustrating a display apparatus in accordance with an embodiment of the present invention;

FIG. 2 is a block diagram illustrating a frame compensating part in FIG. 1;

FIG. 3 is a plan view illustrating an operating process of a motion presumption part in accordance with a first embodiment of the present invention;

FIG. 4 is a plan view illustrating an operating process of a motion presumption part in accordance with a second embodiment of the present invention;

FIG. 5 is a plan view illustrating an operating process of a motion presumption part in accordance with a third embodiment of the present invention;

FIG. 6 is a flow chart illustrating a driving method of the display apparatus in FIG. 1; and

FIGS. 7A, 7B, and 7C are images explaining the driving method in FIG. 6.

### DESCRIPTION OF THE EMBODIMENTS

In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

Hereinafter, the present invention will be explained in detail with reference to the accompanying drawings.

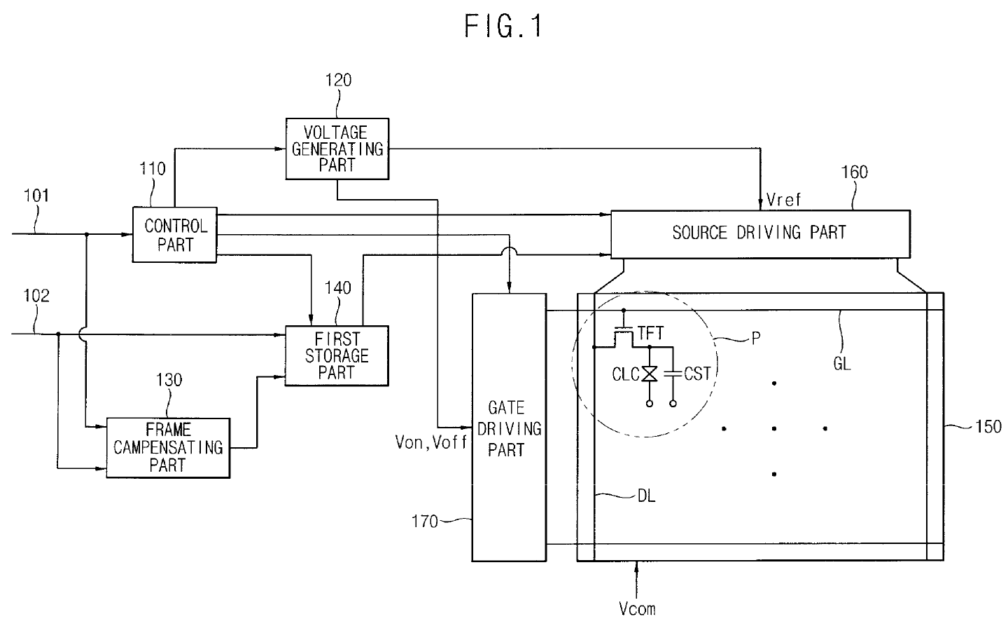

FIG. 1 is a block diagram illustrating a display apparatus in accordance with an embodiment of the present invention.

Referring to FIG. 1, a display apparatus includes a control part 110, a voltage generating part 120, a frame compensating part 130, a first storage part 140, a display panel 150, a source driving part 160 and a gate driving part 170.

The control part 110 generates a driving control signal based on an original control signal 101 received from an external graphic controller (not shown), and controls the operation of the display apparatus based on the driving control signal. For example, when the frame frequency of the original control signal 101 is about 60 Hz, the frame frequency of the driving control signal is more than about 120 Hz.

The voltage generating part 120 generates driving voltages for driving the display apparatus. For example, the driving voltages includes a common voltage Vcom for driving the display panel 150, a standard gray-scale voltage Vref for driving the source driving part 160 and gate voltages Von and Voff for driving the gate driving part 170.

The frame compensating part 130 outputs a compensating frame based on the motion of the frame received from the external graphic controller. For example, the frame compensating part 130 outputs a first compensating frame compensating the whole frame when the received frame is a global image, and outputs a second compensating frame partially compensating the frame when the received frame is a scroll image. Also, the frame compensating part 130 outputs a third compensating frame repeating the received frame when the received frame is a normal image.

A motion vector of the global image has substantially a constant direction and size. A motion vector of the scroll image does not have a substantially constant direction and size, but the motion vector at a vertical (or horizontal) direction has a constant size in the upper and lower (or left and right) portions of the frame.

The first storage part 140 records and reads out the received frame and the compensating frame in every frame, based on the control of the control part 110. For example, the control part 10 may read out the received frame and the compensating frame from the first storage part 140 based on the driving control signal. For example, the driving control signal may have a frequency of about 120 Hz).

The display panel 150 includes a plurality of pixel parts P defined by source wirings DL and gate wirings GL crossing each other. Each of the pixel parts P includes a switching device TFT electrically connected to each of the source wiring and each of the gate wirings, a liquid crystal capacitor CLC electrically connected to the switching device TFT and a storage capacitor line CST.

The source driving part 160 outputs the received frame and the compensating frame read from the first storage part 140 to the source wirings DL based on the driving control signal. For example, the driving control signal may have a frequency of about 120 Hz. The source driving part 160 outputs a data signal of the received frame to the source wirings DL in a first period of one frame period, and outputs a data signal of the compensating frame in a second period. The frame period may be about 16.7 ms. Each of the first and second periods may be about half the 16.7 ms frame period.

The gate driving part 170 outputs gate signals to the gate wirings GL based on a control of the control part 110 in the first period, and outputs substantially the same signal as the gate signals to the gate wirings GL in the second period. A gate signal is applied twice to a corresponding gate wiring in a horizontal period 1H.

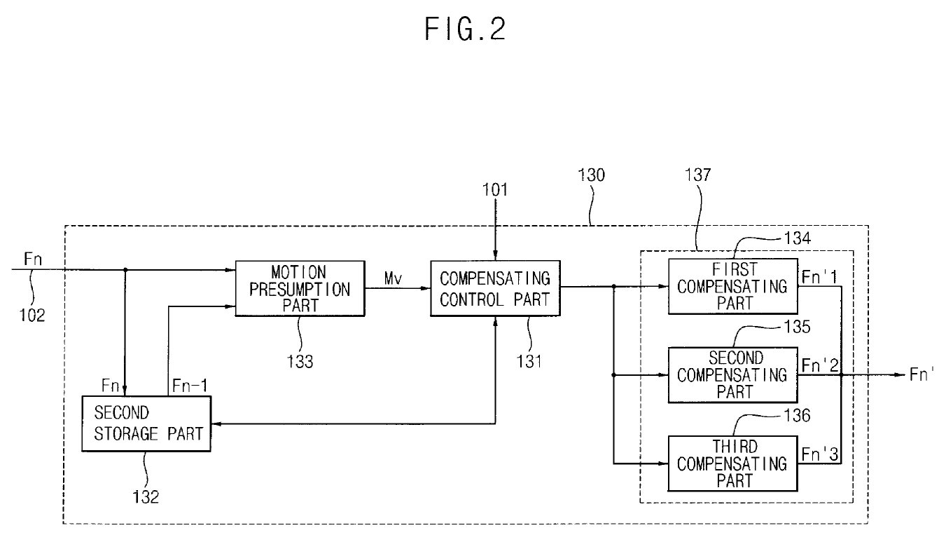

FIG. 2 is a block diagram illustrating a frame compensating part in FIG. 1.

Referring to FIGS. 1 and 2, the frame compensating part 130 includes a compensating control part 131, a second storage part 132, a motion presumption part 133, and a compensating part 137.

The compensating control part 131 controls the operation of the frame compensating part 130 based on the original control signal 101.

The received frame that is received based on the control of the compensating control part 131 is recorded in the second storage part 132, and a previous frame is read.

The motion presumption part 133 calculates a motion vector Mv_n of an n-th frame Fn by using the n-th frame Fn and an (n-1)-th frame Fn-1 read from the second storage part 132, wherein n is a natural number.

The motion presumption part 133 simply calculates the motion vector Mv_n. The motion vector Mv_n is used for determining the kind of motion picture of the n-th frame Fn. A complex operating process may not be required for an accurate motion vector.

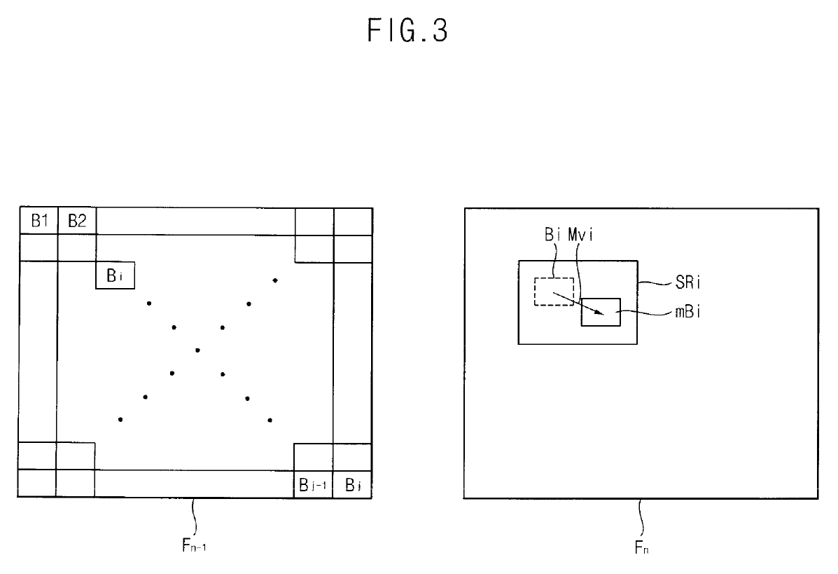

The motion presumption part 133 calculates the motion vector Mv_n of the n-th frame Fn by various simple operating processes such as reducing searching range and reducing resolution. The simple operating processes of the motion presumption part 133 will be explained later with reference to FIGS. 3, 4 and 5.

The compensating control part 131 determines the kind of motion picture of the n-th frame Fn based on the motion vector Mv_n of the n-th frame Fn, and controls the operation of the compensating part 137.

The compensating part 137 includes a first compensating part 134, a second compensating part 135 and a third compensating part 136, and selectively drives the first compensating part 134, the second compensating part 135 and the third compensating part 136 based on the control of the compensating control part 131, and generates an n-th compensating frame Fn′.

When the motion vector Mv_n of the n-th frame Fn has substantially a constant direction and size, the compensating control part 131 determines that the n-th frame Fn is the global image, and controls the first compensating part 134 to generate the first compensating frame Fn′1.

The first compensating part 134 generates and outputs the first compensating frame Fn′1 compensating the whole n-th frame Fn. For example, when the motion vector Mv_n of the n-th frame Fn has a great size, the first compensating part 134 generates the first compensating frame Fn′1 close to black. When the motion vector Mv_n has a small size, the first compensating part 134 generates the first compensating frame Fn′1 close to white. The first compensating frame Fn′1 is generated according to the size of the motion vector Mv_n of the n-the frame Fn.

When the motion vector Mv_n of the n-th frame Fn has various directions and sizes and a motion vector Mv_n in upper and lower (or left and right) portions has a constant size in a horizontal (or vertical) direction, the compensating control part 131 determines a display image as the scroll image, and controls the second compensating part 135 to generate a second compensating frame Fn′2.

The second compensating part 135 generates and outputs the second compensating frame Fn′2 partially compensating the n-th frame Fn. For example, when a subtitle is displayed in a lower part of a screen, the second compensating frame Fn′2 is generated by partially compensating the lower part of the n-th frame Fn. The second compensating frame Fn′2 is substantially the same as the n-th frame Fn except the lower part.

When the displayed image is determined as not the global image and not the scroll image, the compensating part 131 controls the third compensating part 136 to form the third compensating frame Fn′3. The third compensating part 136 outputs the n-th frame Fn as the third compensating frame Fn′3.

FIG. 3 is a plan view illustrating the operating process of a motion presumption part in accordance with a first embodiment of the present invention.

Referring to FIG. 3, a size of a searching range is reduced to reduce an amount of calculating operation of a motion vector.

A motion vector Mv_n of the n-th frame Fn is calculated by a block matching algorithm (BMA) by using two sequential frames which may be the (n-1)-th frame Fn-1 and the n-the frame Fn. The n-1 th frame Fn-1 is divided into j-number of blocks B1, B2, . . . , Bj, and a search range defined in the n-th frame Fn is searched with respect to each blocks, and a motion vector is obtained by finding the most matching block, wherein j is a natural number.

For example, concerning an l-th block of the (n-1)-th frame, an i-th matching block mBi may be found by searching an i-th search range SRi of the n-th frame Fn. A motion vector Mvi is calculated by the horizontal motion component and the vertical motion component of the i-th matching block mBi with respect to the i-th block Bi. Consequently, each search range DRI is reduced, and the area SRi compared by each of the blocks Bi is reduced, so that a total amount of the calculating operation is reduced.

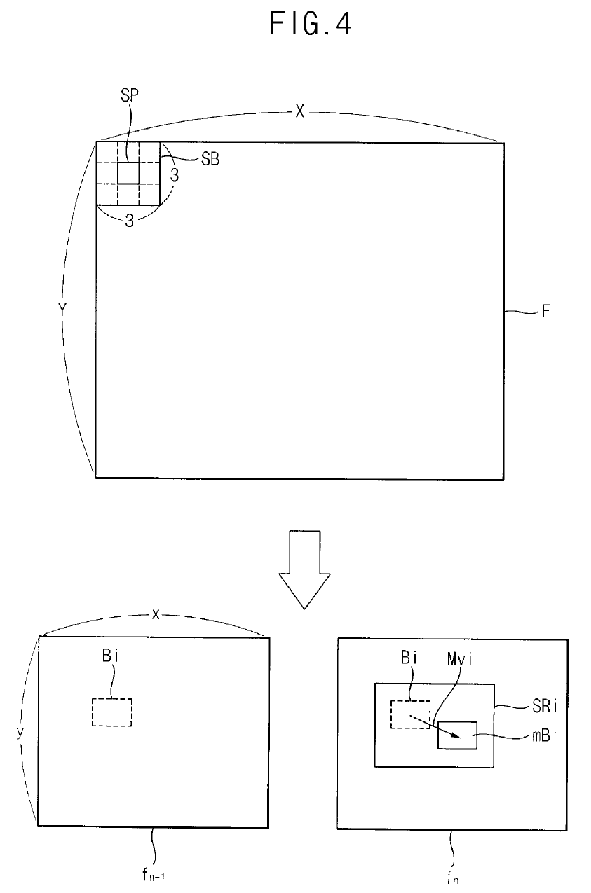

FIG. 4 is a plan view illustrating an operating process of a motion presumption part in accordance with a second embodiment of the present invention.

Referring to FIG. 4, the n umber of calculating operations of a motion vector Mvi is reduced by reducing the resolution of the frame.

The motion presumption part 133 reduces the resolution of the frame, and presumes a movement. For example, a frame having an X1×Y1 resolution is reduced to an X2×Y2 resolution by a sub sampling method.

The X1 and Y1 is greater than X2 and Y2, respectively, and X1, Y1 and X2, Y2 are natural numbers. The sub sampling method may include dividing the X1×Y1 resolution into 3×3 sub blocks, sampling one pixel SP from each sub block SB and reducing the total resolution to a ⅓ scale.

A motion vector Mv_n of the n-th frame Fn is calculated using an (n-1)-th frame Fn-1 and an n-th frame Fn of the reduced resolution. A method of calculating the motion vector Mv_n is substantially the same as the method in FIG. 3. The reduced frame is divided into j-number of blocks, and the motion vector is calculated by searching each of the blocks. Consequently, the resolution is reduced, so that a total number of calculating operations is reduced.

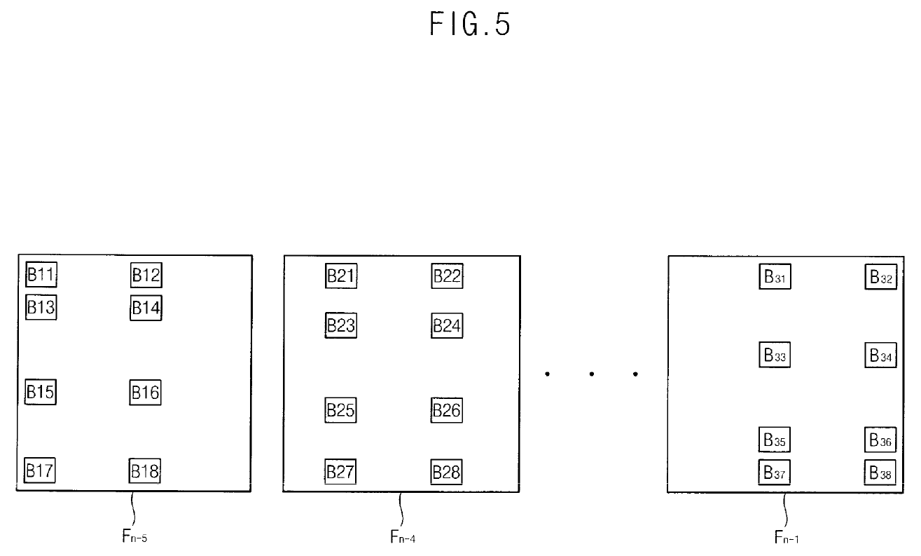

FIG. 5 is a plan view illustrating an operating process of a motion presumption part in accordance with a third embodiment of the present invention.

Referring to FIG. 5, an amount of a calculating operation is reduced by changing a position of k-number of blocks of frames, wherein ‘k’ is larger than the ‘j’, and k and j are natural numbers.

For example, the operation processes mentioned above in accordance with the first and second embodiments calculate motion vectors of total j-number of blocks during a frame period (about 16.7 ms). However, the operation process mentioned later calculates the motion vector of a total of k-number of blocks during the frame period (about 16.7 ms), so that the number of calculating operation is reduced relatively.

The motion presumption part 133 presumes a motion vector of the n-th frame Fn by using sequential previous frames Fn-5, Fn-4, Fn-3, Fn-2 and Fn-1 of the n-th frame Fn.

The motion presumption part 133 sets k-number of first blocks B11, B12, . . . , B1k at a specific position of an (n-5)-th frame Fn-5. For example, k may be 8. The eight first blocks B11, B12, . . . , B18 may be arranged from an upper portion of the screen toward a lower portion of the screen through a central portion of the screen. A first matching blocks is searched using the first blocks B11, B12, . . . , B18 through an (n-4)-th frame Fn-4 and a block matching algorithm, so that a first motion vector is calculated.

The motion presumption part 133 sets second blocks B21, B22, B28 having different positions with respect to the first blocks B11, B12, . . . B18 at the (n-4)-th frame Fn-4. Positions of the first blocks B11, B12, B18 and the second blocks B21, B22, . . . , B28 may be changeable regularly or irregularly.

A second motion vector is calculated by comparing the second blocks B21, B22, . . . , B28 to an (n-3)-th frame Fn-3. A fifth motion vector is calculated by comparing (n-1)-th blocks B31, B32, . . . , B38 of the (n-1)-th frame Fn to an n-th frame Fn.

The motion presumption part 133 calculates a plurality of motion vectors by using sequential frames Fn-5, Fn-4, Fn-3, Fn-2, Fn-1 and Fn, and analyzes a plurality of the motion vectors to determine a motion vector Mv_n of an n-th frame FN.

If k is higher number, the motion vectors reflect more past data. If K is lower number, the motion vectors reflect more recent data. K may be between about 5 and about 20.

A plurality of the motion vectors is calculated using the continuous frames (Fn-5, Fn-4 . . . , Fn) of the embodiment of the present invention. However, the number of frames (Fn-h, Fn-(h-1) . . . , Fn) may be between about 5 and about 10. h is a natural number.

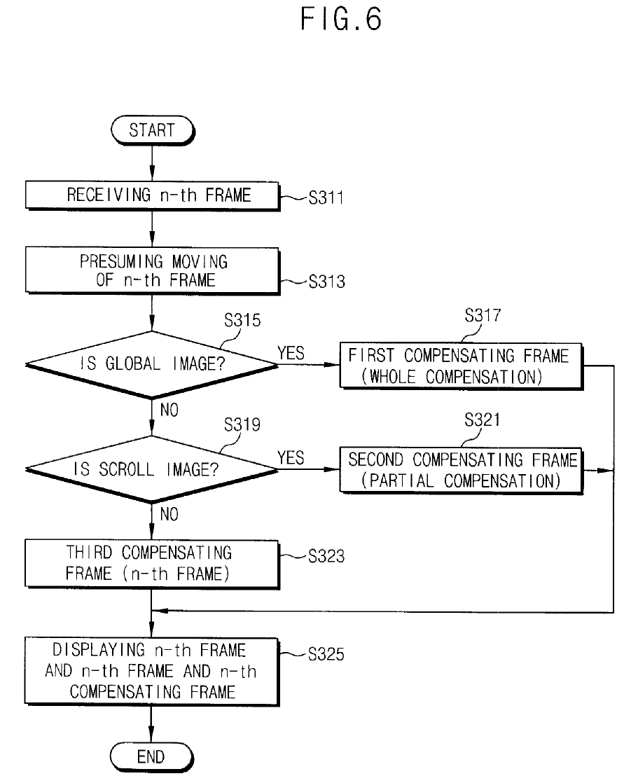

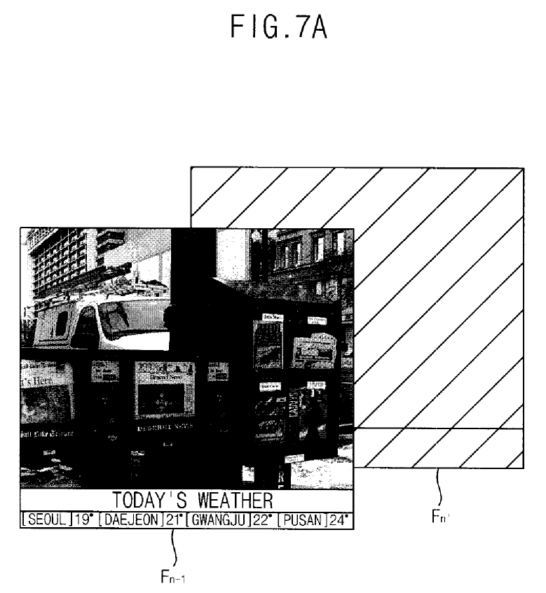

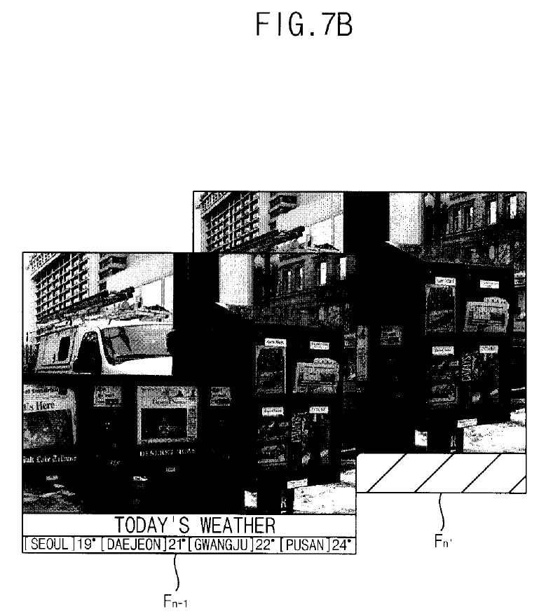

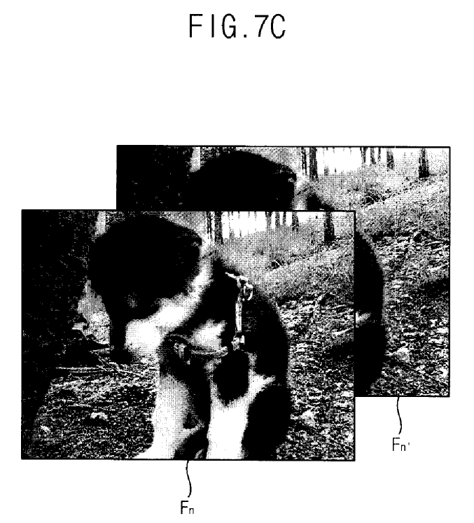

FIG. 6 is a flow chart illustrating a driving method of the display apparatus in FIG. 1, and FIGS. 7A, 7B and 7C are images explaining the driving method in FIG. 6.

Referring to FIGS. 1, 2 and 6, the display apparatus receives an n-th frame Fn and an original control signal from an external graphic controller (step S311). The control part 110 stores the n-th frame Fn to the first storage part 140, and generates a driving control signal (for example, about 120 Hz) based on the original control signal to control an operation of the display apparatus.

The n-th frame Fn is input to the frame compensating part 130, and is stored to the second storage part 132 under a control of the compensating part 131.

The motion presumption part 133 calculates a motion vector Mv_n of the n-th frame Fn by using the n-th frame Fn and a previous frame read from the second storage part 132. The motion presumption part 133 may calculate the motion vector Mv_n of the n-th frame Fn by using the (n-1)-th frame Fn-1 as illustrated in FIGS. 3 and 4, or may calculate the motion vector Mv_n of the n-th frame by using sequential previous frames Fn-5, Fn-4, Fn-3, Fn-2 and Fn-1 as illustrated in FIG. 5.

The compensating control part 131 firstly determines whether the n-th frame Fn is a global image by the motion vector Mv_n of the n-th frame Fn (step S315). The compensating part 131, when the n-th frame Fn is determined to be a global image, controls the first compensating part 134 to generate the n-th compensating frame Fn′ (step S317).

When the size of the motion vector Mv_n of the n-th frame Fn is great, the first compensating part 134 generates the first compensating frame Fn′1 which is close to black. When the size of the motion vector Mv_n of the n-th frame Fn is small, the first compensating part 134 generates the first compensating frame Fn′1 which is close to the original brightness of the n-th frame Fn.

In the first determining process, when the n-th frame Fn is not a global image, the compensating control part 131 next ascertains whether the n-th frame is a scroll image. When the n-th frame Fn is determined as a scroll image, the compensating control part 131 controls the second compensating part 135 to generate the n-th compensating frame Fn′ (step S321).

The second compensating part 135 generates and outputs a second compensating frame Fn′2 partially compensating the n-th frame Fn, as illustrated in FIG. 7B. For example, when a subtitle is displayed in a lower portion of a screen, a second compensating frame Fn′2 including partially compensated lower portion of the n-th frame is generated. The second compensating frame Fn′2 is substantially the same as the n-th frame except the lower portion.

In the second determining process (step S319), when the n-th frame Fn is not the scroll image, the compensating control part 131 ascertains whether the n-th frame Fn is a normal image. The compensating control part 131 controls the third compensating part 136 to generate the n-th compensating frame Fn′ S323.

The third compensating part 136 outputs the n-th frame Fn as a third compensating frame Fn′3 as illustrated in FIG. 7C.

In the processes mentioned above (step S31 7, step S321 and step S323), when the n-th compensating frame Fn′ is generated, the control part 110 stores the n-th compensating frame Fn′ to the first storage part 140.

When the n-th compensating frame Fn′ is stored to the first storage part 140, the control part 110 reads out the n-th frame Fn stored before, outputs the n-th frame Fn to the source driving part 160, and outputs the n-th compensating frame Fn′ to the source driving part 160.

The source driving part 160 outputs the n-th frame Fn to the source wirings DL based on the driving control signal (for example, about 120 Hz) in a first frame period (about 16.7 ms), and outputs the n-th compensating frame FN′ to the source wirings DL in a second frame period.

The gate driving part 170 outputs gate signals to the gate wirings GL under a control of the control part 110 in the first frame period, and outputs substantially the same signals as the gate signals to the gate wirings GL in the second frame period.

Consequently, the n-th frame Fn image and the n-th compensating image in sequence are displayed to the display panel 150 during one frame period (about 16.7 ms).

According to the present invention, the motion of the frame of the received motion picture is presumed, and the kind of motion picture is determined as one of a global image, a scroll image, a normal image and so on, and appropriately compensates th e image according to the kind of motion picture. Therefore, the image blur is removed and display quality of the motion picture may be improved.

In the scroll image, motion is detected in the received frame, so that image blur of the subtitle is removed.

Moreover, the simple motion presumption process which obtains just the kind of the motion picture is applied to display the image, so that the design of hardware is simplified and a manufacturing cost is reduced.

Those of some skill in this art will appreciate that many modifications, substitutions and variations can be made in and to the materials, apparatus, configurations and methods of the display panels of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A method of driving a display apparatus, comprising:
receiving an n-th frame in a frame period,;
presuming a motion of the n-th frame by using the n-th frame and a frame previous to the n-th frame;
determining the kind of motion picture of the n-th frame based on the presumed motion;
generating an n-th compensating frame according to the kind of motion picture; and
displaying the n-th frame and the n-th compensating frame, in sequence, wherein ‘n’ is a natural number.

2. The method of claim 1, wherein displaying the n-th frame and the n-th compensating frame comprises:
displaying the n-th frame in a first period of the frame period; and
displaying the n-th compensating frame in a second period of the frame period.

3. The method of claim 1, wherein presuming the motion comprises calculating a motion vector of the n-th frame by a block matching algorithm by using the (n-1)-th frame and the n-th frame.

4. The method of claim 1, wherein presuming the motion comprises calculating motion vectors in different areas of the n-th frame and a plurality of previous frames just prior to the n-th frame to presume a motion vector of the n-th frame.

5. The method of claim 1, wherein determining the kind of motion picture comprises determining the n-th frame as one of a global image, a scroll image and a normal image.

6. The method of claim 5, wherein the n-th frame is determined as the global image when a motion vector of the n-th frame has a constant direction and size.

7. The method of claim 6, wherein generating the n-th compensating frame comprises compensating totally the n-th frame to generate the n-th compensating frame.

8. The method of claim 7, wherein a gray-scale of the n-th compensating frame is adjusted according to a size of the motion vector of the n-th frame.

9. The method of claim 5, wherein the n-th frame is determined as the scroll image when a motion vector of the n-th frame has a constant direction and size in upper and lower portions or left and right portions of the frame.

10. The method of claim 9, wherein generating the n-th compensating frame comprises partially compensating the n-th frame to generate the n-th compensating frame.

11. The method of claim 5, wherein the n-th frame is determined as a normal image when the n-th frame is neither the global image nor the scroll image.

12. The method of claim 11, wherein generating the n-th compensating frame comprises generating the n-th compensating frame substantially the same as the n-th frame.

13. A method of detecting a global image, comprising:
calculating a plurality of motion vectors from the changing positions of k-number of blocks of an n-th frame and a plurality of previous frames just prior to the n-th frame;
presuming a motion vector of the n-th frame by analyzing the motion vectors; and
determining the n-th frame as a global image when the motion vector of the n-th frame has a constant direction and size, wherein ‘n’ and ‘k’ are natural numbers.

14. The method of claim 13, wherein the positions of k-number of blocks is changed regularly at each frame.

15. The method of claim 13, wherein ‘k’ is between about 5 and about 20.

16. The method of claim 13, wherein calculating the motion vectors comprises calculating the motion vectors by using about 5 to about 10 previous frames.

17. A display apparatus comprising:
a motion presumption part presuming a motion of an n-th frame by using the n-th frame received in a frame period and a stored previous frame prior to the n-th frame, n being a natural number;
a compensating control part determining the kind of motion picture of the n-th frame based on the presumed motion;
a compensating part generating an n-th compensating frame according to the kind of the motion picture; and
a display panel displaying the n-th frame and the n-th compensating frame in the frame period.

18. The display apparatus of claim 17, wherein the motion presumption part calculates a motion vector of the n-th frame by a block matching algorithm by using an (n-1)-th frame and the n-th frame.

19. The display apparatus of claim 17, wherein the motion presumption part presumes a motion vector of the n-th frame by calculating motion vectors of the n-th frame and a plurality of previous frames just prior to the n-th frame in different areas.

20. The display apparatus of claim 17, wherein the compensating control part determines the n-th frame as a global image when a motion vector of the n-th frame has a constant direction and size,
and determines the n-the frame as a scroll image when a motion vector of the n-th frame has a constant direction and size in upper and lower portions or left and right portions of the frame,
and determines the n-th frame as a normal image when the n-th frame is neither the global image nor the scroll image.

21. The display apparatus of claim 20, wherein the compensating part comprises:
a first compensating part generating a first compensating frame, the first compensating frame formed by totally compensating the n-th frame;
a second compensating part generating a second compensating frame, the second compensating frame formed by partially compensating the n-th frame; and
a third compensating part generating a third compensating frame formed as substantially the same as the n-th frame.

22. The display apparatus of claim 21, wherein the compensating control part controls the first compensating part to output the first compensating frame as the n-th compensating frame when the n-th frame is the global image,
and controls the second compensating part to output the second compensating frame as the n-th compensating frame when the n-th frame is the scroll image,
and controls the third compensating part to output the third compensating frame as the n-th compensating frame when the n-th frame is the normal image.

23. The display apparatus of claim 22, wherein the first compensating part adjusts a gray-scale of the first compensating frame according to size of the motion vector of the n-th frame.

24. The display apparatus of claim 17, wherein the display panel comprises a plurality of pixel parts defined by source wirings and gate wirings crossing each other, and
each of the pixel parts comprises a switching device electrically connected to each of the source wirings and each of the gate wirings and a liquid crystal capacitor electrically connected to the switching device.

25. The display apparatus of claim 24, further comprising:
a source driving part outputting the n-th frame to the source wirings in a first period of the frame period and outputting the n-th compensating frame to the source wirings in a second period of the frame period; and
a gate driving part outputting gate signals to the gate wirings in the first period and outputs substantially the same signals as the gate signals to the gate wirings in the second period.
